(19) United States
(12) Patent Application Publication
(10) Pub. No.: US 2003/0020988 A1
(43) Pub. Date: Jan. 30, 2003

(54) Optical lens for improved vision under conditions of low or poor illumination

(76) Inventor: Robert F. Stone, Manorville, NY (US)

Correspondence Address: Kelly & Hulme, P.C., 323 Mill Road, Westhampton Beach, NY, 11978, US

(21) Appl. No.: 09/912,916

(22) Filed: Jul. 25, 2001

(51) Int. Cl. G02C 7/02

(52) U.S. Cl. 359/159

(57) ABSTRACT

An eyeglass lens having a power of from about a minus 0.12 to about minus 1.00 diopters (and preferably minus 0.50 diopters) that is particularly beneficial and improves vision of a user under night or other low-light conditions. The lens may be incorporated in a pair of eyeglass frames and may be used by users without corrective eyewear or in a pair of clip-on” frames for use by a user already requiring corrective eyewear.

### BACKGROUND OF THE INVENTION

1. Field of Invention

The present invention is related generally to vision wear such as eyeglasses, sunglasses, or eyeglass “clip-ons”, and the like; and more particularly to an optical lens for use in enhancing nighttime vision and for use during nighttime driving.

2. Description of Prior Art

Many people, whether they require vision correction or not, often experience reduced visual acuity (poor vision) at night. This phenomenon, called night myopia, results from physical changes in the eye resulting from the low light conditions experienced at night. The physical manifestation of night myopia is blurred vision under these conditions of reduced light.

The normal human eye in “seeing” an object is, in reality, viewing the light rays reflected off an object which rays pass through the pupil of the eye and are focused on the retina by the operation of the eye's cornea and lens.

The source of the above described myopia is found in the fact that when the normal human eye experiences a condition of low or poor illumination the pupil of the eye dilates (grows larger). The more dilation the pupil experiences, the less well the cornea offsets the natural spherical and oblique aberrations (optical distortion) of the eye causing blurred vision. The lower the illumination, the greater the dilation and the greater the blurring of the viewed object.

Additionally, the spherical and oblique aberrations result in an increased image size on the retina of the eye, which, in turn, stimulates the process of accommodation. Accommodation is typically related to the change in the lens of the eye to focus on objects at different distances from the viewer. Under low light conditions, however, the lack of focus caused by the aberrations stimulates the accommodation of the eye to reduce that image size, which further results in a myopic shift in the refracting power of the eye.

The shift in refracting power resulting from the spherical and oblique aberrations, and the accommodation process cause the eye to focus the light rays entering the eye at a point other than the retina, thereby producing the above described blurred vision. Under these conditions of shifted refracting power, in order to obtain clear vision, the eye focus must be adjusted back to the appropriate refracting power.

A typical human eye has, as a result of the above processes, been found to experience a shift in refracting power varying from minus 0.12 to minus 1.00 diopters, under night vision conditions. This has been found to be true whether or not an individual requires vision correction or not to achieve normal vision.

The above described process and the resulting degradation in clarity, and acuity of vision under conditions of poor illumination results in increased danger when performing activities such as driving, operating equipment, ambulating, and the like under such visual conditions.

It is therefore the object of the present invention to provide a lens for use in association with the human eye offsetting or eliminating the above described vision degrading processes.

It is another object of the present invention to provide such a lens as can be used by individuals already using prescriptive eye correction, as well as those who do not require such vision correcting eyewear.

It is yet another object to provide such a lens that is easy to use and/or incorporate with an individuals existing eyewear.

It is yet another object of the present invention to provide an eyeglass frame in the form of spectacles, “clip-on” frames, or the like, incorporating the lens of the present invention.

These and other objects will become apparent from the following specifications, read in conjunction with the appended claims and attached drawings which form a part of this application.

### SUMMARY OF THE INVENTION

The above objects, and others, are provided by a typical eyeglass lens having a power of about a minus 0.12 to minus 1.00 diopters and preferably minus 0.50 diopters. Where the user does not require other correction, the lenses having the indicated power may be incorporated into a standard pair of eyeglass frames for use by individuals in improving vision of the user under night or other low-light conditions.

Where the user requires refractive correction for any pre-existing vision problems, the above-described change in refracting power may be incorporated into such user's existing eyewear. This may be accomplished by providing such user with a corrective lens with a change in the power of the user's corrective lens equal to the above range. More preferable, however, a user already wearing corrective lenses may be provided with a pair of “clip-on” lenses having a refractive power as defined above which may be attached to user's corrective lenses when such user is experiencing night or low-light conditions.

In addition and if desired, the lens of the present invention may contain any suitable coating and/or additive typically provided in vision wear. These coatings or additives may include but are not limited to tints, anti-reflective coatings, ultra-violet and visible light absorbers, lens darkening additives and the like. Furthermore, the lens may be of any described shape.

### BRIEF DESCRIPTION OF THE DRAWINGS

FIG. 1 is a perspective view of a pair of spectacles incorporating the lens of the present invention; and

FIG. 2 is a perspective view of an alternate embodiment of the present invention showing the lens of the present invention, incorporated into a “clip-on” frame, for attachment to a pair of standard eyeglasses.

### DETAILED DESCRIPTION OF THE PRESENT INVENTION

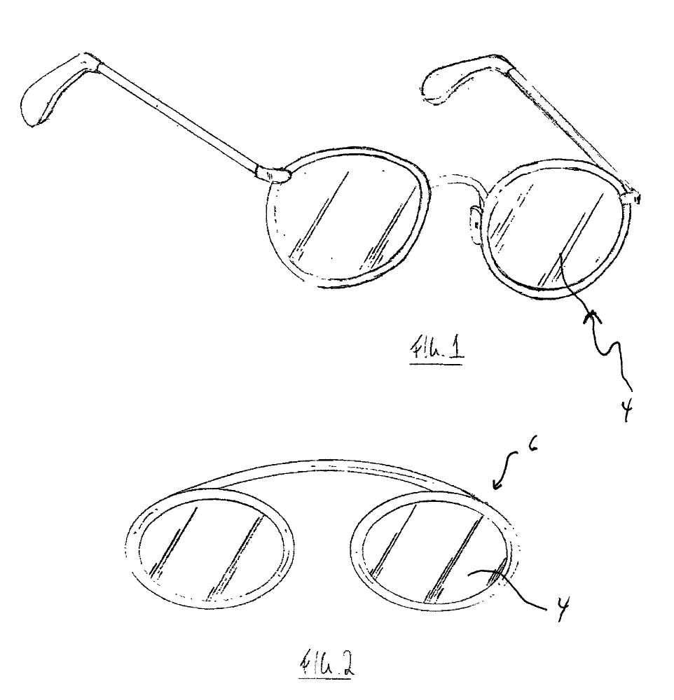

Referring to FIG. 1, there is seen a typical pair of spectacles incorporating the lenses 4 of the present invention with the lens having a shape corresponding to the eye glass frames selected by a user.

As described above, the lenses 4 have a power of from about minus 0.12 to minus 1.00 diopters.

The use of such lenses during low light and nighttime driving, ambulating, equipment operation, and the like, results in improved acuity and vision and adequately adjusts for the refractive shift often experienced when attempting to see under conditions of poor illumination.

The applicant herein and through his own work in the field, has found that although the lens power necessary to achieve the benefit of the present invention may vary based on the user, such range is not a function of a user's pre-existing prescription and is most typically achieved with a lens 4 having a power of minus 0.50 diopters.

Referring to FIG. 2, there is seen an alternate embodiment of the present invention showing the lenses 4 incorporated into a “clip-on” frame 6 for attachment to a user's existing eyeglasses when needed.

A user of the spectacles and/or clip-ons 6 incorporating the novel lens 4 of the present invention will benefit primarily under night or low-light conditions.

Lens 4 may be formed from any suitable transparent material such as glass or plastic. In addition, the benefits exhibited through the use of lens 4 of the present invention may be enhanced by a tint added to the lens 4 and/or an anti-reflective coating, as well as any other suitable and typical lens additives or enhancement. Specifically, a yellow tint having a 10% light absorption may be most advantageous employed in the present invention. The tinting provides for enhanced contrast and brightness.

Finally, an anti-reflective coating on the lens 4 using any suitable material such as Magnesium Fluoride may be used to further enhance the present invention by reducing headlight reflection and glare from the surfaces of lens 4.

It will be obvious to one skilled in the art, that the enhancements provided in the lens 4 of the present invention may be achieved by incorporating the above described features into a user's existing eyewear. However, while improving night vision while using these glasses, their use under a better or fully illuminated condition is not recommended.

While certain specific relationships, materials and other parameters have been discussed above, those features can be varied, with suitable similar results within the spirit of the application. These and other applications, variations and features of the invention will occur to those skilled in the art upon reading the present disclosure, such features, application, and the like, being included within the scope of the invention as defined in the appended claim.

What is claimed is:

1. An optical lens for use in association with the human eye for improving vision under conditions of low or poor illumination which is comprised of a substantially transparent optical lens with a refractive power of from about minus 0.12 to minus 1.00 diopters, which lens, when located in front of a human eye, provides the necessary shift in the refractive power of said eye to improve vision under said low light conditions.

2. The lens of claim 1 having a power of minus 0.50 diopters.

3. The lens of claim 1 incorporated into a standard pair of eyeglasses.

4. The lens of claim 1 incorporated into a “clip-on” pair of glasses for use in combination with a standard pair of eyeglasses.

5. The lens of claim 1 further including a tint to enhance contrast of the lens.

6. The lens of claim 1 further including an anti-reflective coating.
